(19) United States
(12) Patent Application Publication
(10) Pub. No.: US 2005/0271050 A1
(43) Pub. Date: Dec. 8, 2005

(54) Domain-influenced prefix assignment method and apparatus

(75) Inventors: Ali Akgun, Chicago, IL (US); Ravideep Bhatia, West Dundee, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 10/861,577

(22) Filed: Jun. 4, 2004

(51) Int. Cl. H04L 12/66

(52) U.S. Cl. 370/389

(57) ABSTRACT

A network element (10) can retain a plurality of prefix identifiers as are used to formulate an address to be used by individual network users. Pursuant to a preferred approach, one or more of these prefix identifiers are pre-correlated to a given domain name while at least one other prefix identifier is pre-correlated to the absence of a domain name. So configured, a specific prefix identifier can be allocated for use by a given network user as a function, at least in part, of the domain name (or lack of a domain name) as may be presented by that network user when seeking to establish a network connection.

### FIELD OF THE INVENTION

This invention relates generally to address-based network communications and more particularly to determination of a prefix portion of an address.

### BACKGROUND OF THE INVENTION

Communication networks of various kinds are known. Many such networks anticipate that various communication nodes or elements, such as a client platform, will have a unique (or at least a sufficiently unique) network address to facilitate the appropriate routing of messages to and from such platforms. In some cases these addresses are more or less permanently assigned to a given corresponding platform. In other cases, however, and particularly when working to accommodate mobile client platforms, temporary addresses are often better suited to the task.

Since most (if not all) networks typically have only a finite number of potential address resources, provision of temporary addresses can present problems. For example, without proper management the demand for concurrent allocation of temporary addresses can appear to outstrip available resources. Accordingly, many modem networks employ processes to aid in ensuring that temporary addresses are more likely to be issued and maintained only as and while genuinely needed.

While suitable for at least some operational contexts, present address allocation schemes do not necessarily provide a satisfactory answer for all settings. Consider Internet Protocol version 6 (IPv6) as one illustrative example. IPv6 addresses are comprised of a 64 bit prefix and a 64 bit interface identifier. When a mobile client (or other device seeking a temporary address) establishes a point-to-point protocol connection with a packet data switching node it negotiates the interface identifier portion of the address during a network control protocol interaction (conforming, for example, to IPv6CP) stage of establishing the point-to-point protocol connection. After the point-to-point protocol link converges, the mobile client receives a router advertisement from the packet data switching node that contains one more prefixes. The mobile client typically combines one of these prefixes with the negotiated interface identifier and configures its IPv6 address accordingly.

In some cases, overall communications and/or resource management can be better facilitated if a given mobile client is assigned one prefix as versus another prefix that may also be available for such assignment. For example, a given network may support mobile clients that are associated with differing domains (or with mobile clients that themselves are capable of seeking affiliation at any given time with a given domain that is but one of many candidates). At present, such networks have no viable mechanism to accommodate such circumstances.

### BRIEF DESCRIPTION OF THE DRAWINGS

The above needs are at least partially met through provision of the domain-influenced prefix assignment method and apparatus described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a schematic block diagram view as configured in accordance with various embodiments of the invention; and

FIG. 4 comprises a schematic view of an address block as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION OF THE PREFERRED EMBODIMENTS

Generally speaking, pursuant to these various embodiments, the assignment of a network identifier to a wireless network user is facilitated by providing a pool of candidate prefix identifiers, wherein at least one of the candidate prefix identifiers is pre-associated with a specific network domain name and wherein at least one of the candidate prefix identifiers is not pre-associated with any network domain names. Upon receiving a communication from the wireless network user, one determines whether the communication identifies the specific network domain name. When true, one then at least attempts to affiliate the wireless network user with the candidate prefix identifier that is pre-associated with that specific network domain name. When not true, one then at least attempts to affiliate the wireless network user with the candidate prefix identifier that not pre-associated with any specific network domain name.

Depending upon the application, the pool of candidate prefix identifiers can include additional candidate prefix identifiers. If desired, some of these candidates can be pre-associated with yet other supported network domain names. Pursuant to another approach, a plurality of candidate prefix identifiers can be pre-associated with a corresponding single network domain name.

Pursuant to one embodiment, the prefix identifiers as correspond to a given domain name can be comprised of at least one fixed portion and at least one non-fixed portion. So configured, the non-fixed portion can be allocated to assure uniqueness amongst all mobile clients that are affiliating with a common domain name while the fixed portion of the prefix identifier will be the same for these same mobile clients.

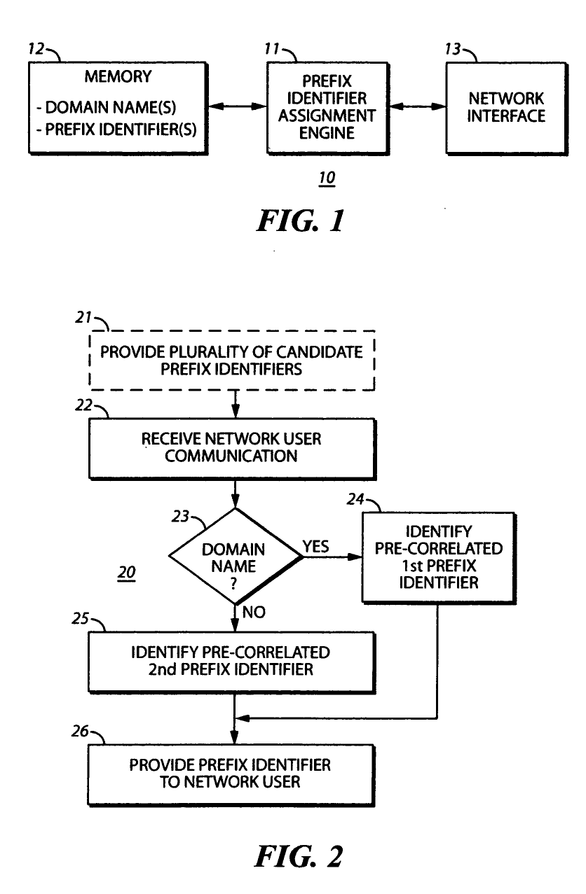

Referring now to the drawings, and in particular to FIG. 1, an illustrative embodiment, suitable to support these teachings, will be described. Those skilled in the art will recognize that other supporting platforms could be similarly employed as may best suit the needs and requirements of a given application setting.

A network element 10 (such as but not limited to a packet data switching node, a home agent, an authentication, authorization, and accounting server, a gateway general packet radio service support node, and the like) can comprise a prefix identifier assignment engine 11 that operably couples to a memory 12 and a network interface 13. Many network elements comprise partially or wholly programmable platforms. Such network elements can therefore be readily programmed to accord with these teachings and to, in particular, provide the prefix identifier assignment engine capabilities described herein. If desired, of course, a dedicated purpose platform could be provided in lieu of a programmable solution.

The network interface 13 will preferably comprise an interface that supports compatible interaction between the network element 10 and a network to which the network element couples. For example, the network interface 13 can comprise a session initiation protocol-compatible interface that compatibly interacts using appropriate voltage levels, signaling protocols, and the like as may correspond to the network in order to facilitate communications with one or more network users (and particularly network users who seek to establish a network connection).

In general, such platforms and interfaces are well understood in the art. In addition, these teachings are not especially owing to a selection of any particular platform, network, protocol, or the like. Therefore, for the sake of brevity and the preservation of focus, additional details in this regard will not be provided except where appropriate and/or helpful by way of illustration.

In a preferred embodiment, the memory 12 contains one or more specific domain names and a pool of candidate prefix identifiers comprising one or more different prefix identifiers. In a preferred approach, at least one of the prefix identifiers is pre-correlated to one of the domain names and another of the prefix identifiers is not pre-correlated to any of the domain names.

So configured, the prefix identifier assignment engine 11 serves to provide prefix identifiers to network users that seek to establish a network connection. More particularly, and as will be presented with greater elaboration below, the prefix identifier assignment engine 11 can apportion such prefix identifiers as a function, at least in part, of a domain name as may be presented by such a network user when seeking to establish that network connection.

Referring now to FIG. 2, a process 20 to effect such a capability will be described. Pursuant to a preferred (but optional) approach, this process 20 provides 21 a plurality of candidate prefix identifiers. (If not provided a priori, it might be possible to provide some other derivation process and/or access scheme to accommodate an eventual need for such identifiers.) The number of candidate prefix identifiers provided, and the type, style, or format of candidate prefix identifiers provided, can vary as desired to suit the needs of a given application. For example this plurality of candidate prefix identifiers could be comprised of only a first prefix identifier and a second prefix identifier. Or, if desired (and as is more likely the case), a third or yet further additional candidate prefix identifiers can be similarly provided.

As noted earlier, at least one of these candidate prefix identifiers is preferably pre-correlated to a given corresponding domain name. When the process 20 supports multiple domain names, then various of the multiple domain names will preferably each be pre-correlated with at least one of the candidate prefix identifiers. In a preferred approach, at least one of these candidate prefix identifiers will also not be pre-correlated with any specific domain name (and, in many embodiments, a plurality of such candidates will not be pre-correlated with any specific domain names).

Upon then receiving 22 a communication from a network user (such as, for example, a wireless network user) seeking to establish a network connection (such as, for example, a network control protocol IPv6-compatible communication that seeks to establish a point-to-point protocol communication), the process 20 then determines 23 whether that network user presents a domain name in conjunction with that communication. When that network user does present a domain name, this process 20 then preferably identifies 24 a prefix identifier (or plurality of identifiers) (for example, from amongst the plurality of candidate prefix identifiers when so provided) that is pre-correlated to that domain name.

Upon identifying such a prefix identifier (or identifiers), the process 20 then provides 26 such prefix identifier (or identifiers) to the network user. Provisioning this prefix identifier can be accomplished in any of many various ways. Pursuant to one approach, advertising (as per, for example, the accommodations of IPv6) can be used to advise the network user of this prefix identifier (or identifiers). Such advertising can be effected, for example, through use of a router advertisement message in accord with known prior art technique. The network user can then make use of that advertised or otherwise provided prefix identifier to configure and comprise its own address for use during subsequent network interactions.

When the process 20 identifies 24 more than one candidate prefix identifier, more than one candidate can be provided 26 to the network user. For example, if 15 candidate prefix identifiers are so identified, the process 20 can provide all 15 candidates, or some lesser subset, to the network user (again, for example, through use of a router advertising message). Pursuant to this approach, the recipient network user can then select at least a given one of the provided plurality of prefix identifiers for use as noted above.

When this process 20 does not discern presentation of a domain name by a network user, the process 20 instead then identifies 25 a candidate prefix identifier (or identifiers) that are reserved for use with network users that do not present a domain name. This identified prefix identifier (or plurality of prefix identifiers) is then again provided 26 to the network user to permit use of that prefix identifier to formulate and establish its own network address.

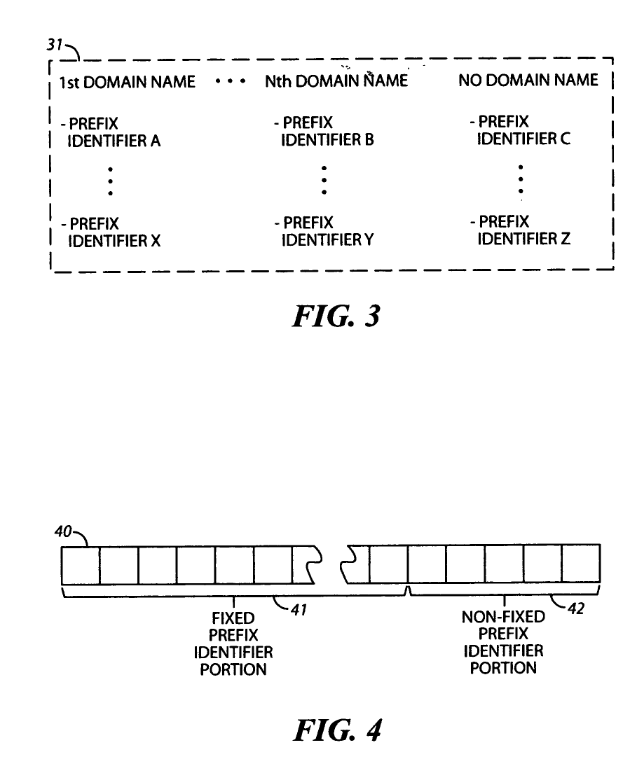

To illustrate, and referring now to FIG. 3, one or tables 31 can serve to retain information regarding one or more domain names and correlated prefix identifiers. For example, a first domain name can have a first plurality of prefix identifiers (i.e., prefix identifier A through prefix identifier X) correlated thereto while other domain names (such as an Nth domain name) can have a different plurality of prefix identifiers (i.e., prefix identifier B through prefix identifier Y) correlated thereto. In a similar fashion, and again in conformance with the teachings set forth above, yet another plurality of prefix identifiers (i.e., prefix identifier C through prefix identifier Z) can be correlated to the absence of a specific domain name. When a network user presents, for example, the first domain name while seeking to establish a network communication, such a table 31 will serve to readily identify a corresponding plurality of prefix identifiers (in this illustrative example, prefix identifier A through prefix identifier X). One or more of these corresponding prefix identifiers can then be provided to the network user for use when constructing its network address.

Such prefix identifiers can be utterly distinct from one another and without any content or formatting relationship to one another if so desired. These teachings are also applicable, however, to use with a more orderly process. For example, a given plurality of prefix identifiers may be identical to one another with respect to a certain portion of the prefix and only differ with respect to one another as per the contents of another portion of the prefix. To illustrate, and referring now to FIG. 4, a given prefix identifier 40 can comprise a fixed prefix identifier portion 41 (formed, for example, of a fixed number of bits) and can also comprise a non-fixed prefix identifier portion 42 (also formed, for example, of a fixed number of bits).

To illustrate, if the complete prefix comprises an eight bit expression, then the first four bits might be identical for each prefix while the remaining four bits vary. Such a scheme would yield, for example, the following pool of candidate prefixes:
11110000
11110001
11110010
11110011
11110100
11110101
11110110
11110111
11111000
11111001
11111011
11111011
11111100
11111101
11111110
11111111

These teachings encompass an approach wherein such a plurality of prefix identifiers are all associated with a given domain name (such as, for example, “domain1.net”). So apportioned, all prefixes that begin with “1111” would be used exclusively in support of network users that present “domain1.net” as their domain (by presenting, for example, “networkuser@domain1.net”). The remaining prefix portions could then be allocated as needed amongst appropriate network users. For example, a first network user might receive “11110000” as their prefix identifier while a next network user presenting this same domain name might receive a next sequential prefix identifier (i.e., “11110001”). In this way a given network user will receive a prefix identifier having at least one portion that is correlated to a specific domain name and that will be shared with other network users and another prefix identifier portion that serves to uniquely identify this particular network user.

Such an approach can be readily used in an IPv6 context. IPv6 provides for a 64 bit prefix identifier. A first portion of that prefix identifier, such as the first 48 bits, could be fixed for a given plurality of prefix identifiers as are correlated to a given corresponding domain name. The remaining 16 bits could then comprise a variable portion that serve to facilitate unique identification of each network user as corresponds to the given domain name.

Those skilled in the art will appreciate that such prefix identifiers as comprise both a fixed and a non-fixed portion can be stored and/or allocated in various ways. By one approach, each possible complete prefix identifier can be stored in a table in conjunction with a corresponding domain name (or the absence of a domain name). By another approach, only the fixed portion of such a prefix identifier need be stored in a table. So configured, the fixed portion would be extracted as being correlated to a given presented domain name and the non-fixed portion could then be allocated on, for example, a round robin or sequentially incremented basis. Though a same basic end result occurs, the latter approach likely requires less memory than the first approach.

So configured, a network element such as a packet data switching node can maintain a table that correlates domain names with associated prefixes (either complete prefixes or fixed portions thereof as explained above) as well as prefixes that are reserved for use with network users that present no domain information (including, if desired, unrecognized and/or unsupported domain information). When a network user presents a domain name (or fails to present a domain name) during, for example, point-to-point protocol negotiation and/or its network access identifier during, for example, Mobile Internet Protocol registration, the network element can use this domain name information to lookup a corresponding prefix identifier (or identifier portion) and facilitate a router advertisement that presents that prefix identifier (or identifiers when more than one prefix identifier are to be presented).

These teachings readily facilitate the efficient handling and support of network users that present differing domain names. Prefix management in particular can be efficiently controlled to accommodate various system management goals and practices.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, a network user may from time to time present a domain name, but that domain name may be unrecognized or, for whatever reason, there may be no prefix identifiers that have a pre-established correlation to that domain name. In such a case, the above process can be readily applied by treating the unrecognized or otherwise unsupported domain name as no domain name. In such a case, a prefix identifier as corresponds to no domain name could then be allocated.

1. A method comprising:
receiving a communication from a network user seeking to establish a network connection;
when the communication presents a domain name as corresponds to the network user:
identifying a first prefix identifier as having been pre-correlated to the domain name;
providing to the network user the first prefix identifier;
when the communication does not present a domain name as corresponds to the network user:
providing to the network user a second prefix identifier, which second prefix identifier is reserved for use with network users that do not present a domain name.

2. The method of claim 1 wherein receiving a communication from a network user seeking to establish a network connection further comprises receiving the communication pursuant to establishment of a point-to-point protocol communication.

3. The method of claim 2 wherein receiving the communication pursuant to establishment of a point-to-point protocol communication further comprises receiving the communication during a network control protocol stage of establishing a point-to-point protocol communication.

4. The method of claim 1 wherein receiving a communication from a network user seeking to establish a network connection further comprises receiving a communication from a wireless network user seeking to establish a network connection.

5. The method of claim 4 wherein receiving a communication from a wireless network user seeking to establish a network connection further comprises receiving the communication during a network control protocol stage of an Internet Protocol version 6 control protocol compatible communication establishing a point-to-point protocol communication.

6. The method of claim 1 wherein identifying a first prefix identifier as having been pre-correlated to the domain name further comprises identifying a first prefix identifier as having been pre-correlated to the domain name from amongst a plurality of candidate prefix identifiers.

7. The method of claim 6 wherein providing to the network user a second prefix identifier, which second prefix identifier is reserved for use with network users that do not present a domain name further comprises selecting the second prefix identifier from amongst the plurality of candidate prefix identifiers.

8. The method of claim 1 and further comprising:
providing a plurality of candidate prefix identifiers.

9. The method of claim 8 wherein providing a plurality of candidate prefix identifiers further comprises providing a plurality of candidate prefix identifiers that include the first prefix identifier and the second prefix identifier.

10. The method of claim 9 wherein providing a plurality of candidate prefix identifiers that include the first prefix identifier and the second prefix identifier further comprises providing a plurality of candidate prefix identifiers that includes at least a third prefix identifier.

11. The method of claim 10 wherein providing a plurality of candidate prefix identifiers that includes at least a third prefix identifier further comprises providing a plurality of candidate prefix identifiers that includes at least a third prefix identifier that is pre-correlated to a domain name other than the domain name.

12. The method of claim 1 and further comprising, when the communication presents a domain name as corresponds the network user:
advertising the first prefix identifier to the network user.

13. The method of claim 12 wherein advertising the first prefix identifier to the network user further comprises advertising the first prefix identifier to the network user using a router advertisement message.

14. The method of claim 1 and further comprising, when the communication does not present a domain name as corresponds to the network user:
advertising the second prefix identifier to the network user.

15. The method of claim 1 wherein:
when the communication presents a domain name as corresponds the network user:
advertising the first prefix identifier to the network user; and
when the communication does not present a domain name as corresponds to the network user:
advertising the second prefix identifier to the network user.

16. The method of claim 1 and further comprising:
providing a first plurality of prefix identifiers;
correlating the first plurality of prefix identifiers with a first specific domain name;
providing a second plurality of prefix identifiers;
correlating the second plurality of prefix identifiers with an absence of a specific domain name.

17. The method of claim 16 and further comprising:
providing a third plurality of prefix identifiers;
correlating the third plurality of prefix identifiers with a second specific domain name, which second specific domain name is different that the first specific domain name.

18. The method of claim 1 wherein identifying a first prefix identifier comprises identifying the first prefix identifier from amongst a plurality of prefix identifiers that are each pre-correlated to the domain name.

19. The method of claim 18 wherein identifying a first prefix identifier further comprises identifying a first plurality of prefix identifiers from amongst a plurality of prefix identifiers that are each pre-correlated to the domain name.

20. The method of claim 19 wherein providing to the network user the first prefix identifier further comprises providing to the network user the first plurality of prefix identifiers.

21. The method of claim 20 wherein providing to the network user the first plurality of prefix identifiers further comprises advertising the first plurality of prefix identifiers to the network user using at least one router advertisement message, such that the network user can select at least a given one of the first plurality of prefix identifiers to use.

22. The method of claim 21 wherein identifying a second prefix identifier further comprises identifying a second plurality of prefix identifiers from amongst a plurality of prefix identifiers that are each reserved for use with network users that do not present a domain name.

23. The method of claim 22 wherein providing to the network user the second prefix identifier further comprises providing to the network user the second plurality of prefix identifiers.

24. The method of claim 23 wherein providing to the network user the second plurality of prefix identifiers further comprises advertising the second plurality of prefix identifiers to the network user using at least one router advertisement message, such that the network user can select at least a given one of the second plurality of prefix identifiers to use.

25. The method of claim 1 wherein identifying a first prefix identifier comprises identifying the first prefix identifier as being an only prefix identifier as has been pre-correlated with the domain name.

26. The method of claim 1 wherein identifying a first prefix identifier as having been pre-correlated to the domain name further comprises identifying a first prefix identifier having a fixed first portion that is only assigned to network users presenting the domain name.

27. The method of claim 26 wherein identifying a first prefix identifier having a first portion that is only assigned to network users presenting the domain name further comprises specifying a second portion of the first prefix identifier to uniquely identify the network user.

28. The method of claim 1 wherein identifying a first prefix identifier as having been pre-correlated to the domain name further comprises accessing a table containing information that correlates domain names with prefix identifiers.

29. A method to facilitate the assignment of a network identifier to a wireless network user, comprising:
providing a pool of candidate prefix identifiers, wherein at least one of the candidate prefix identifiers is pre-associated with a specific network domain name and wherein at least one of the candidate prefix identifiers is not pre-associated with any network domain names;
receiving a communication from a wireless network user;
determining whether the communication identifies the specific network domain name;
when the communication identifies the specific network domain name, at least attempting to affiliate the wireless network user with the candidate prefix identifier that is pre-associated with the specific network domain name;
when the communication does not identify a specific network domain name, at least attempting to affiliate the wireless network user with the candidate prefix identifier that is not pre-associated with any specific network domain name.

30. The method of claim 29 wherein providing a pool of candidate prefix identifiers further comprises providing a pool of candidate prefix identifiers at a packet data serving node.

31. The method of claim 29 wherein receiving a communication from a wireless network user seeking to establish a network connection further comprises receiving the communication pursuant to establishment of a point-to-point protocol communication.

32. A method to facilitate provisioning a network user with a prefix identifier, comprising:
providing a plurality of specific domain names;
providing at least one fixed prefix identifier portion for each of the plurality of specific domain names;
providing at least one fixed prefix identifier portion that is uncorrelated to a specific domain name;
receiving a communication from a network user seeking to establish a network connection;
when the communication presents a domain name as corresponds to the network user:
identifying at least a first fixed prefix identifier portion as having been pre-correlated to the domain name;
providing to the network user the first fixed prefix identifier portion;
when the communication does not present a domain name as corresponds to the network user:
providing to the network user a second fixed prefix identifier portion as selected from amongst the at least one fixed prefix identifier portion that is uncorrelated to a specific domain name.

33. The method of claim 32 wherein, when the communication presents a domain name as corresponds to the network user:
further providing at least a first non-fixed prefix identifier portion to uniquely correspond to the network user;
and wherein providing to the network user the first fixed prefix identifier portion further comprises providing to the network user the first fixed prefix identifier portion and the first non-fixed prefix identifier portion;
such that network users presenting a given domain name will each share a common portion of a prefix identifier and each will have a unique portion of their prefix identifier to thereby facilitate their unique identification.

34. The method of claim 33 wherein the first fixed prefix identifier portion comprises a first fixed number of bits of a complete prefix identifier and the first non-fixed prefix identifier portion comprises a second fixed number of bits of the complete prefix identifier.

35. The method of claim 34 wherein the first fixed number of bits comprise a first 48 bits of a full Internet Protocol version 6 64 bit prefix identifier and the second fixed number of bits comprise a subsequent 16 bits of the full Internet Protocol version 6 64 bit prefix identifier.

36. A network element comprising:
at least one memory containing:
a plurality of specific domain names;
at least one fixed prefix identifier portion for each of the plurality of specific domain names;
at least one fixed prefix identifier portion that is uncorrelated to a specific domain name;
a network interface to facilitate reception of a communication from a network user seeking to establish a network connection;
a prefix identifier assignment engine operably coupled to the at least one memory and the network interface and being arranged and configured, when the communication presents a domain name as corresponds to the network user:
to identify at least a first fixed prefix identifier portion as having been pre-correlated to the domain name;
to provide to the network user the first fixed prefix identifier portion;
and when the communication does not present a domain name as corresponds to the network user:
to provide to the network user a second fixed prefix identifier portion as selected from amongst the at least one fixed prefix identifier portion that is uncorrelated to a specific domain name.

37. The network element of claim 36 wherein:
when the communication presents a domain name as corresponds to the network user, the prefix identifier engine is further arranged and configured to:
further provide at least a first non-fixed prefix identifier portion to uniquely correspond to the network user;
further provide to the network user the first fixed prefix identifier portion and the first non-fixed prefix identifier portion;
such that network users presenting a given domain name will each share a common portion of a prefix identifier and each will have a unique portion of their prefix identifier to thereby facilitate their unique identification.

38. The network element of claim 37 wherein the first fixed prefix identifier portion comprises a first fixed number of bits of a complete prefix identifier and the first non-fixed prefix identifier portion comprises a second fixed number of bits of the complete prefix identifier. 39. The network element of claim 38 wherein the first fixed number of bits comprise a first 48 bits of a full Internet Protocol version 6 64 bit prefix identifier and the second fixed number of bits comprise a subsequent 16 bits of the full Internet Protocol version 6 64 bit prefix identifier.
